(19) United States
(12) Patent Application Publication
(10) Pub. No.: US 2008/0304963 A1
(43) Pub. Date: Dec. 11, 2008

(54) Tilting flaps to drive wind power generators or gearboxes

(76) Inventor: Riadh M. M. Awni, Amman (JO)

Correspondence Address: David M. Ostfeld;Adams and Reese, LLP, 4400 One Houston Center, 1221 McKinney Street, Houston, TX, 77010, US

(21) Appl. No.: 11/811,074

(22) Filed: Jun. 8, 2007

(51) Int. Cl. F03D 3/00

(52) U.S. Cl. 416/17

(57) ABSTRACT

In order to use wind energy to drive a wind power generator or gearbox we usually use a certain sort of propeller rotates in a plane perpendicular to the wind direction. The “Tilting flap” is a new means to be used to achieve the same task but in more efficient manner, the arrangement of the “Tilting flaps” differs than the propeller unit in two ways. It rotates in a plane parallel to the wind direction. Its “Flaps” change their positions during the rotational movement to face the blowing wind currents wherever are these changes are required to gain the optimum use of the wind energy.

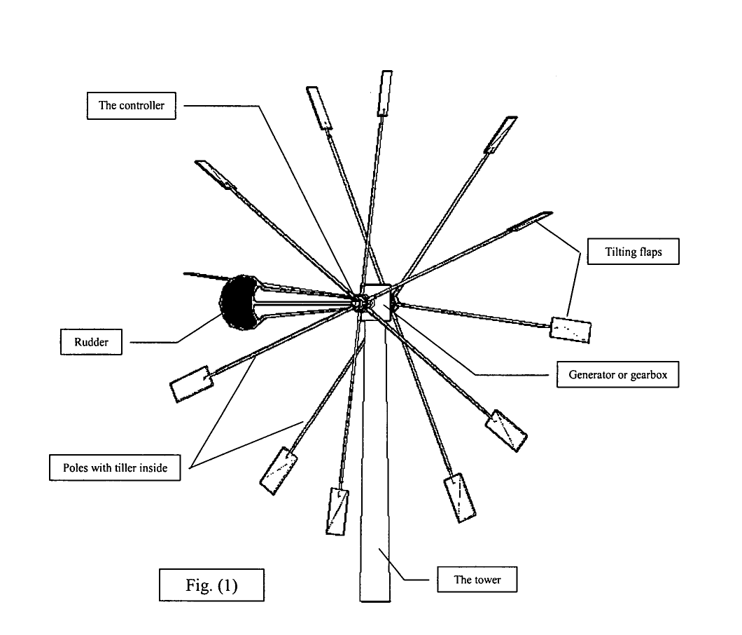

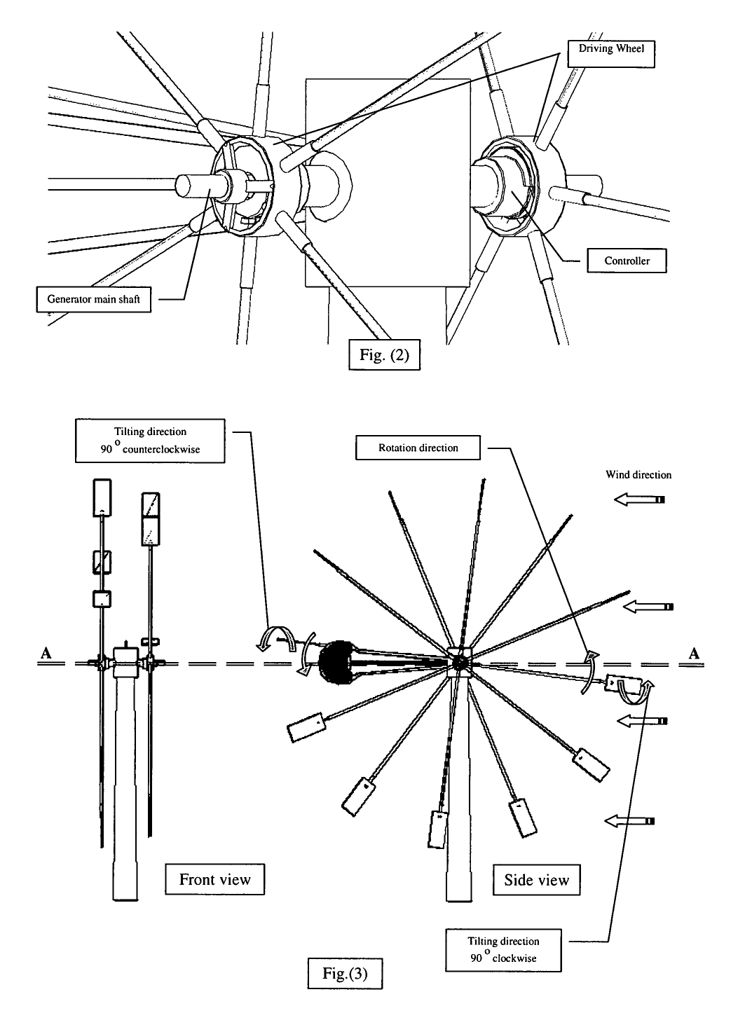

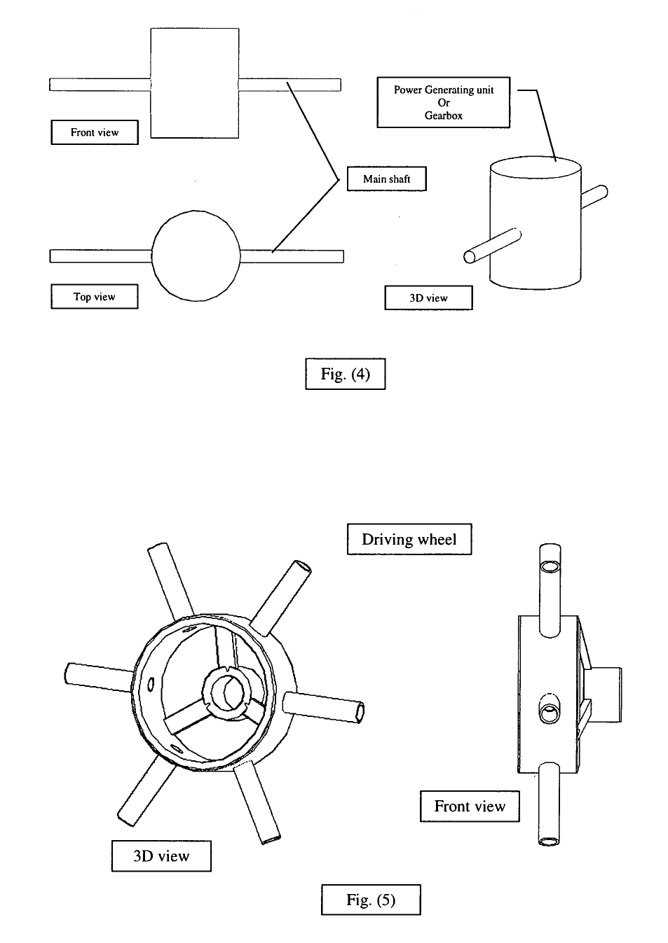

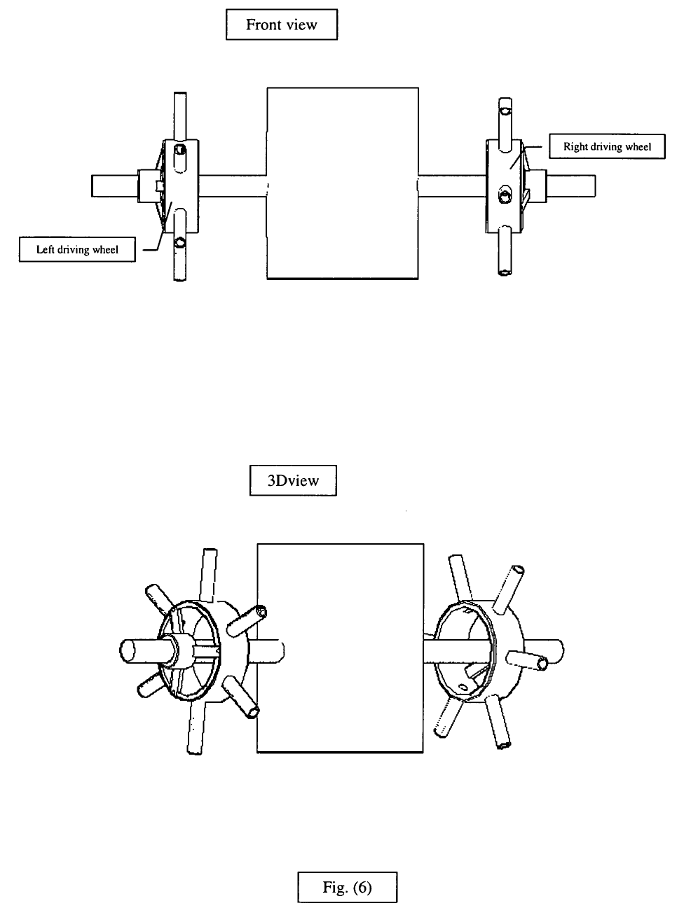

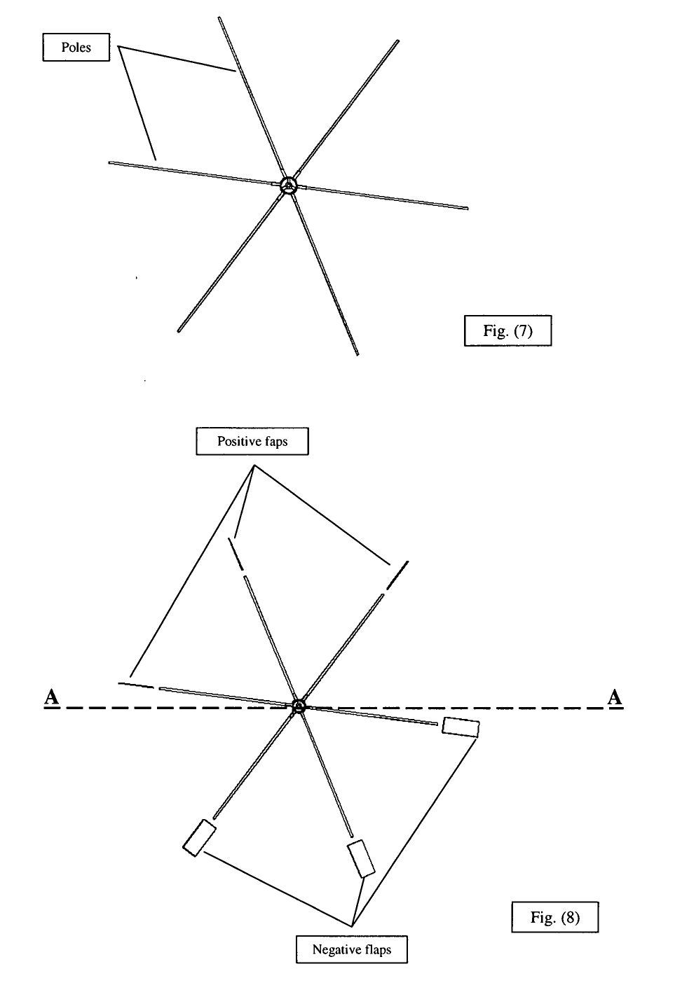

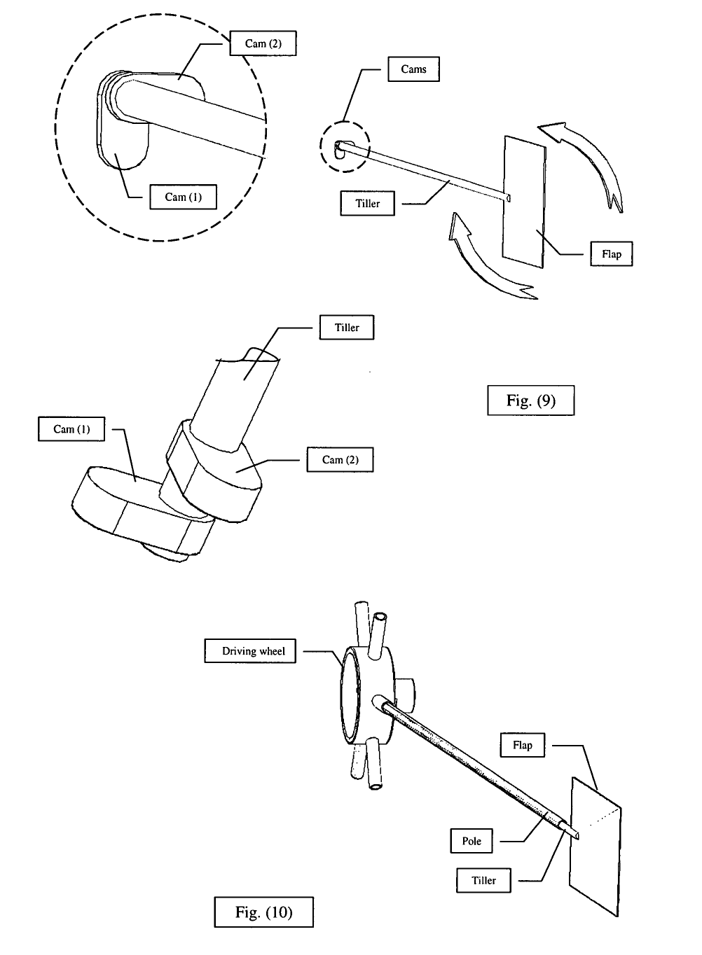

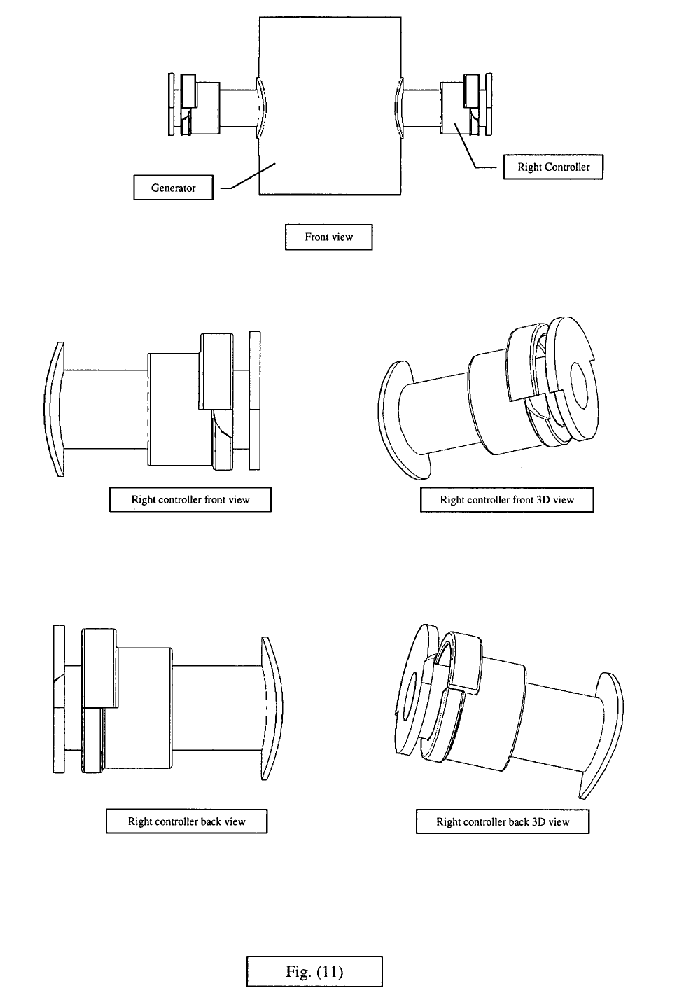

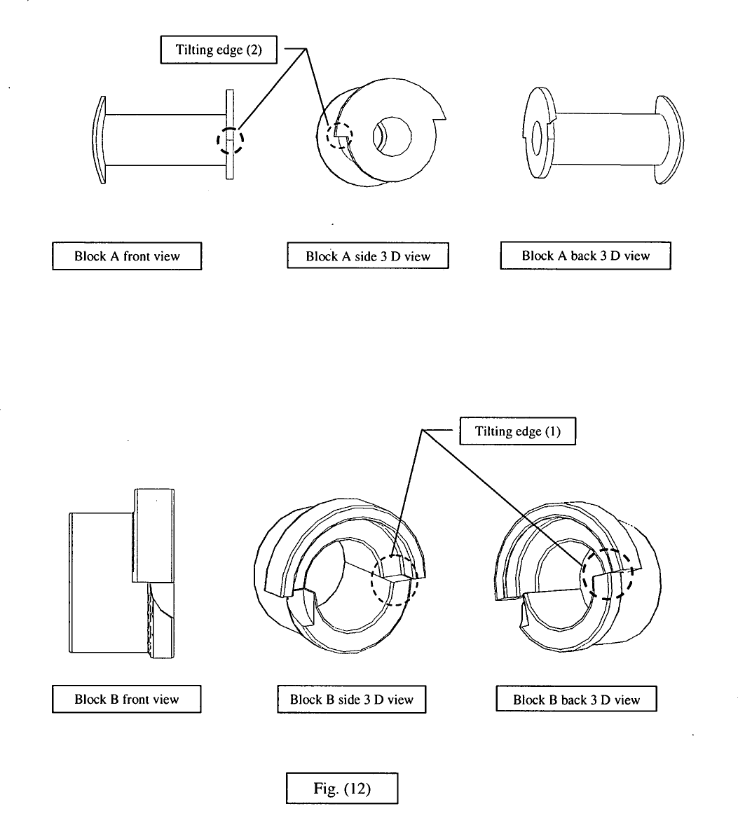

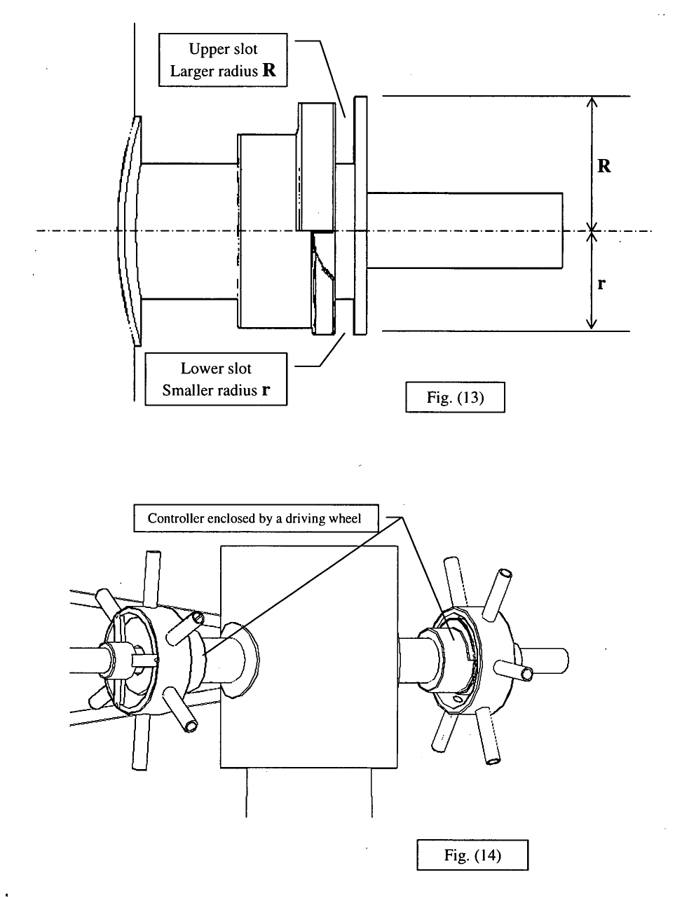

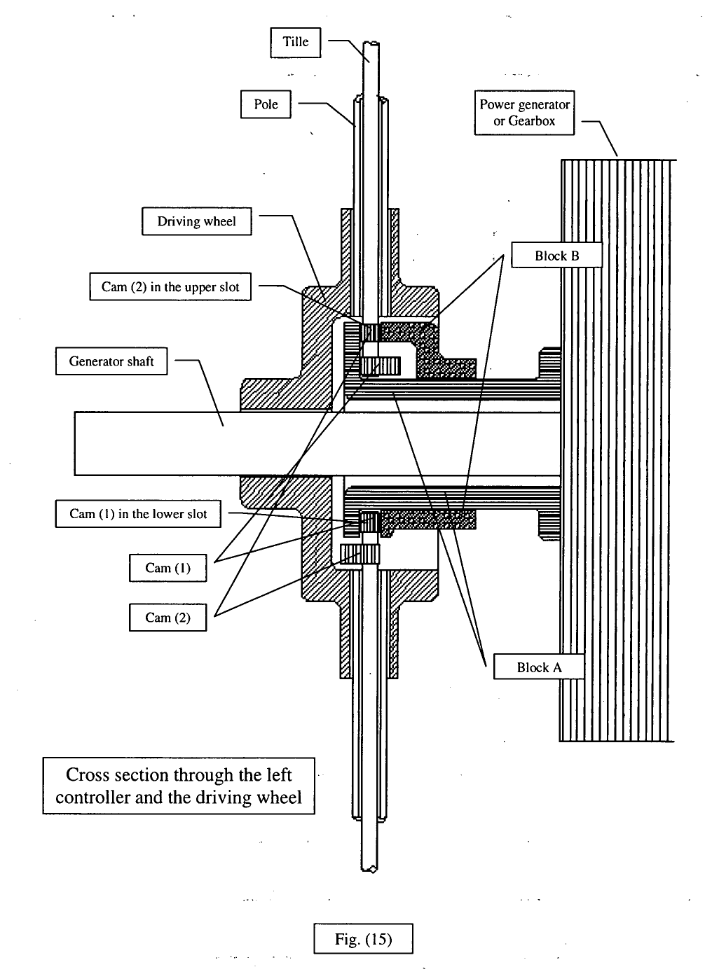

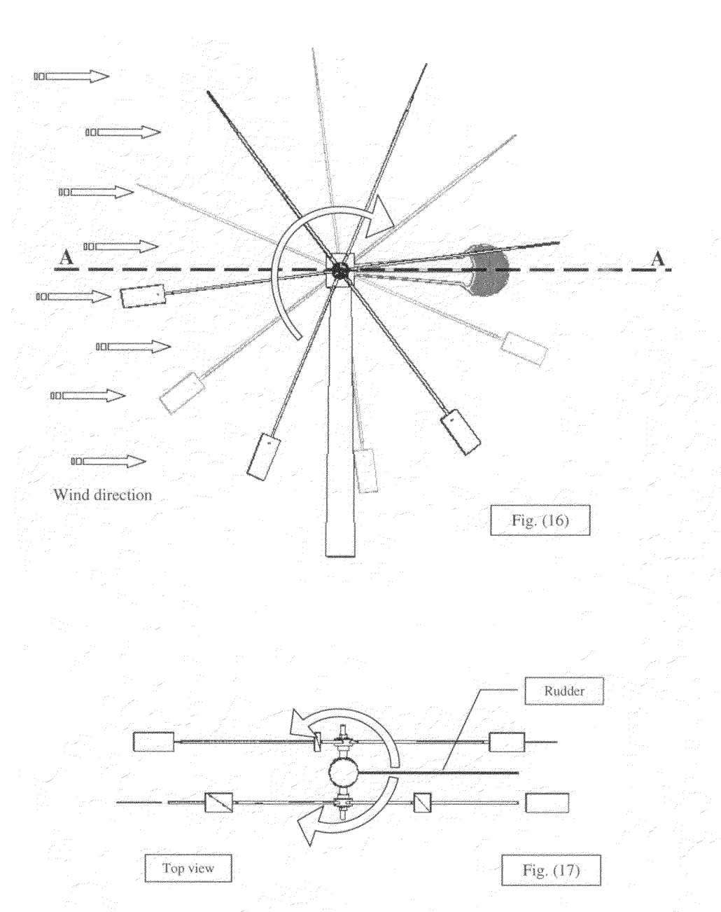

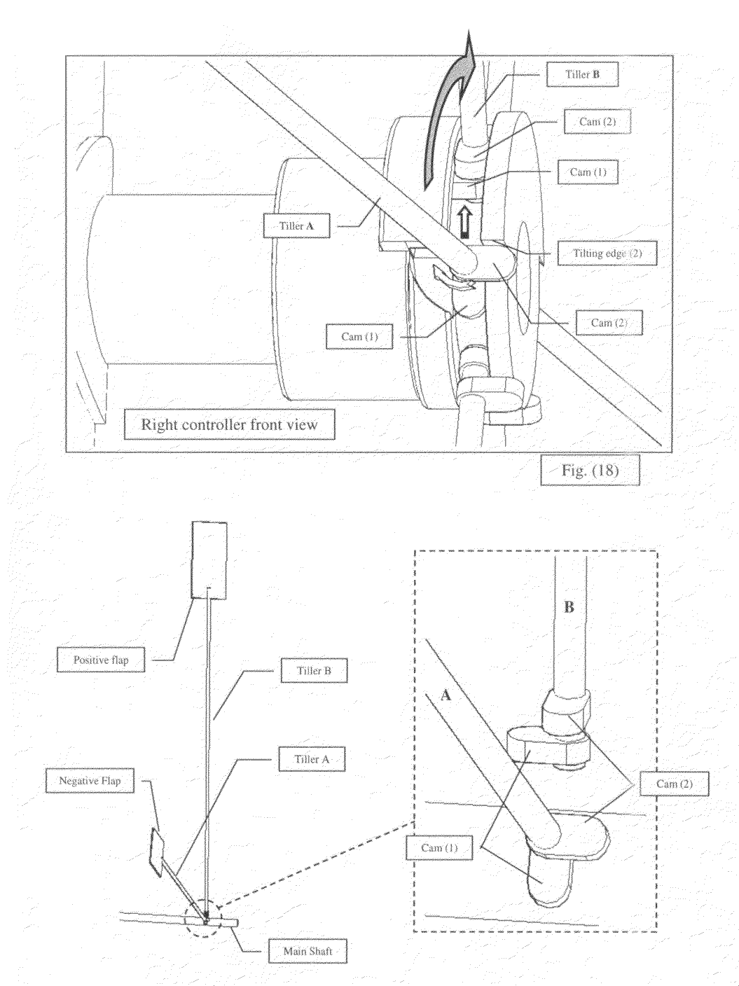

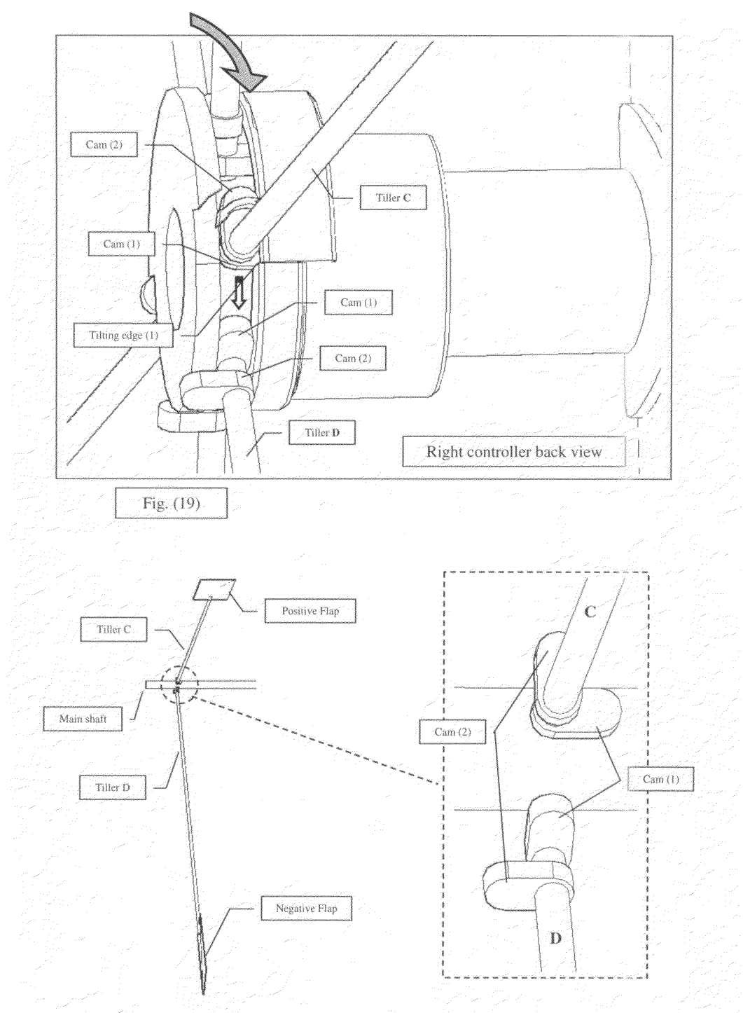

### FIELD OF THE INVENTION

The present invention relates to a new means and method that has been specially prepared to drive wind power generators or gearboxes.

### SUMMARY OF THE INVENTION

This invention “Tilting flaps” has been specially prepared to drive wind power generators or gearboxes. It is a new means and method which is capable to adjust the “Flaps” positions in predetermined location during its rotation around the generator or gearbox axis in order to be perpendicular to the wind currents direction (positive position) to make use of the wind kinetic energy, then they automatically turn to a parallel position to the wind currents direction (negative position) in other predetermined location.

The frequent tilting movement of the “Flaps” between positive to negative positions lead to ensure a continuous and hard drive to the loads to be driven.

### BRIEF DESCRIPTION OF THE DRAWINGS

| | |
|---|---|
| FIG. (1) | General 3D view for the “Tilting flaps” arrangement shows the main following parts: |
| | 1. Tower |
| | 2. Generator or gearbox |
| | 3. Rudder |
| | 4. “Poles” with “Tillers” inside |
| | 5. “Tilting flaps” |
| FIG. (2) | Large 3D view for the generator (or gear box) rests on the top of the tower shows an enlarged |
| | details of the following |
| | 1. Its main shaft |
| | 2. “Driving wheels” (right and left) |
| | 3. “Controllers” (inside the “Driving wheels”) |
| | 4. “Poles” (with “Tillers” inside) |
| FIG. (3) | Front view & Side view for the whole arrangement and the direction of the wind current affecting |
| | the arrangement |
| | Note: |
| | All the “Flaps” located above the dashed line AA are in positive position (perpendicular to the wind |
| | direction) while all “Flaps” below the dashed line AA are in negative position (parallel to the wind |
| | direction). |
| FIG. (4) | Top, Front & 3D views for |
| | 1. Generator (or gearbox) |
| | 2. Main shaft |
| FIG. (5) | Front & 3D view of the right “Driving wheel” |
| FIG. (6) | Front & 3D views for |
| | 1. Generator (or gearbox) |
| | 2. Main shaft |
| | 3. Left & Right “Driving wheel” |
| FIG. (7) | The “Poles” fixed to the “Driving wheel” |
| FIG. (8) | “Tilting flaps” fixed to the “Poles” |
| | Note that the “Flaps” in the zone above the dashed line AA are in positive position while the |
| | “Flaps” in the zone below the dashed line AA are in negative position |
| FIG. (9) | 3D view for the “Tiller” which rests in side the pole with one end connected to the “Flap” which is |
| | able to rotate along with the “Tiller” it self around the longitudinal axis of the “Tiller” while the |
| | other end of the “Tiller” has ended with two “Cams” |
| | 1. “Cam”(1) of a longitudinal axis parallel to the lower “Flap” edge connected to the “Tiller” |
| | 2. “Cam” (2) of a longitudinal axis perpendicular to the lower “Flap” edge connected to the |
| | “Tiller” |
| FIG. (10) | 3D view for a “Tiller” rests inside a pole which is fixed to the “Driving wheel”, Note that the |
| | “Tiller” is completely free to rotate inside the pole governed by the two “Cams” and the controller |
| | to be discussed later. |
| FIG. (11) | Front view of the generator with its two similar “Controllers” (right and left) fixed on its outer |
| | shell, each one of the two “Controllers” is enclosing one of the two ends of the main shaft |
| | Two views (front and back) for the Right controller |
| | Two 3D views (front and back) for he Right controller |
| FIG. (12) | Shows the two components of the controller |
| | 1. Block (A) Front, 3D side & 3D back views |
| | 2. Block (B) Front, 3D side & 3D back views |
| | The drawing shows the locations of the tilting edges |
| | 1. Tilting edge (2) in block (A) side 3D view |
| | 2. Tilting edge (1) in block (B) side 3D view |
| FIG. (13) | The two components of the controller fixed to each other to form a pair of half circular slots of |
| | different radii |
| | 1. Upper slot of the larger radius (R) |
| | 2. Lower slot of the smaller radius (r) |
| FIG. (14) | 3D view shows how the two “Driving wheel” (Right & Left) enclosed the two “Controllers”, Note |
| | that the generator shaft is completely free to rotate inside both of the fixed controller while both of |
| | the “Driving wheels” are fixed to the generator shaft |
| FIG. (15) | A cross sectional view through the Left controller and the enclosing “Driving wheel” showing the |
| | following items |
| | 1. Pole |
| | 2. Tiller |
| | 3. “Cam” (2) in the upper slot |
| | 4. “Cam” (1) in the lower slot |
| | 5. Block (A) |
| | 6. Block (B) |
| | 7. The generator body, Note that the controller is fixed to the generator body |
| | 8. Main shaft, Note that the shaft is free to rotate inside the fixed controller |
| | 9. “Driving wheel”, note that it is fixed to the main shaft |
| FIG. (16) | Side view for the whole arrangement shows the wind direction and the clockwise rotation of the |
| | “Flaps” due to the wind effect upon the “Flaps” of positive positions (all in zone above the dashed |
| | line AA) |
| FIG. (17) | Top view of the whole arrangement shows the ability of the generator to rotate around the |
| | longitudinal axis of the tower due to the effect of wind current upon the rudder in order to make the |
| | arrangement opposing the wind direction |
| FIG. (18) | Front 3D view for the Right controller shows the following: |
| | 1. All “Tillers” (driven by the “Driving wheel”) moving (rotating) in clock wise direction |
| | 2. One of the “Tillers” (“Tiller” A) is just leaving the zone of “Flaps” with negative position |
| | (below the dashed line AA) to enter the zone of “Flaps” with positive position (above the |
| | dashed line AA) |
| | 3. “Cam” (2) (of “Tiller” A) has just touched the tilting edge (2) therefore the “Tiller” will rotate |
| | clockwise by 90° around its longitudinal axis |
| | 4. “Cam” (1) will leave the lower slot |
| | 5. “Cam” (2) will be ready to enter the upper slot. |
| | 6. This 90° rotation of the “Tiller” will change the “Flap” position from negative to positive and |
| | the case of “Tiller” A will be just like the case of “Tiller” B |
| FIG. (19) | Front 3D view for the back controller shows the following: |
| | 1. All “Tillers” (driven by the “Driving wheel”) moving (rotating) in clock wise direction |
| | 2. One of the “Tillers” (“Tiller” C) is just leaving the zone of “Flaps” with positive position |
| | (above the dashed line AA) to enter the zone of “Flaps” with negative position (below the |
| | dashed line AA) |
| | 3. “Cam” (1) (of “Tiller” C) has just touched the tilting edge (1) therefore the “Tiller” will |
| | rotate counterclockwise by 90° around its longitudinal axis |
| | 4. “Cam” (2) will leave the upper slot |
| | 5. “Cam” (1) will be ready to enter the lower slot. |
| | 6. This 90° rotation of the “Tiller” will change the “Flap” position from positive to negative and |
| | the case of “Tiller” C will be just like the case of “Tiller” D |

### DETAILED DESCRIPTION OF THE PREFERRED EMBODIMENT

### Important Note:

This idea concerns only with the method and the means by which we drive an electrical power generator (or a gearbox) using the wind kinetic energy in a most efficient way. Therefore the main subject of what is described hereinafter is the arrangement which is capable to drive an electric power generator (or a gearbox which will drive power generator, water pump, etc. . . . ).

### General Description:

The arrangement of driving wind power generator is shown clearly in FIG. (1), the main duty of this arrangement is to drive the power generator (or gearbox) which rests on the top of a “Tower” of a predetermined height, the power generator is free to move (rotate) clockwise and counterclockwise around the longitudinal axis of the “Tower”, this rotation is governed by the “Rudder” which totally affected by the wind currents to keep the whole arrangement facing the wind direction properly

The driving arrangement consists mainly of the following:
1 “Driving wheels” As shown in FIG. (2), these wheels are fixed to the main shaft of the (Right & Left) generator (or gearbox) and once they rotate the shaft will start rotation as well.
2 “Poles” Predetermined No. of hollow “Poles” (6 in the illustrating drawings) fixed around the perimeter of each of the “Driving wheels” as shown in FIGS. (1) & (2)
3 “Flaps” Wide flatted objects fixed to a “Tiller” rod enclosed in each pole, the “Tiller” is free to rotate inside the pole, So the “Flap” is capable to adjust its position according to its location around the “Generator” Main shaft as shown in FIG. (3) front and side view.
4 “Tiller” Shown in FIGS. (9) & (10), It is a rod connecting the “Flaps” to the controller.
5 “Controllers” Each fixed on the on one of the two sides of the generator shell (Right & Left) surrounding the main shaft, they are responsible upon controlling the tilting movement of the “Flaps”

Referring to FIG. (3) (Side & Front view), note that all “Flaps” in the zone above the dashed line AA are in positive position (facing the wind currents) while all “Flaps” in the zone below the dashed line AA are in negative position (will not affected by wind currents) so the arrangement will be in unbalanced situation which will cause the positive “Flaps” to be pushed to rotate around the “Generator” axis forcing the “Poles” and the “Driving wheels” to rotate in a counterclockwise direction which will lead to drive the generator (or gearbox) in the same rotation direction.

In order to maintain the continuity of this rotational movement we need to ensure the continuity of the following two actions

Each positive “Flap” move from the zone above the dashed line AA to the zone below the dashed line AA must change its position to negative

Each negative “Flap” move from the zone below the dashed line AA to the zone above the dashed line AA must change its position to positive.

The two “Controllers” and the “Tillers” are responsible upon achieving this aim, to understand how they work we must refer to FIGS. (9) & (10) regarding the “Tiller” and FIGS. (11), (12) & (13) regarding the controller.

FIG. (11) shows a Front view of the generator with two “Controllers” (right and left) (both are similar) fixed on its outer shell sides along with two views (front and back) of the Right controller & two 3D views (front and back) of the Right controller

FIG. (12) Shows the two components of the controller,

Block (A): Front, 3D side & 3D back views

Block (B): Front, 3D side & 3D back views

The drawing shows also the locations of the tilting edges

Tilting edge (2) in block (A) side 3D view

Tilting edge (1) in block (B) side 3D view

FIG. (13) shows the two components of the controller fixed to each other to form a pair of half circular slots of different radii

Upper slot of the larger radius (R)

Lower slot of the smaller radius (r)

The two slots have the same width which is suitable for the “Cam” width to pass through the “Tiller”—as illustrated in FIG. (9)—is a rod holding the “Flap” in one of its two end while the other end is provided with two “Cams” (1) & (2) perpendicular to each other, “Cam” (1) is parallel to the lower edge of the “Flap” and “Cam” (2) is perpendicular to it.

As wind currents pushes the positive “Flaps” (in the zone above the dashed line AA) and all other related components i.e. the “Poles”, the “Driving wheels” and finally the generator main shaft, the “Tillers” will move as well due to the movement of their enclosing “Poles”

Following up “Tiller” (A) in FIG. (18) as it is just leaving the zone below the dashed line AA with its negative “Flap” to enter the zone above the dashed line AA we can clearly see a “Cam” (1) is sliding along the lower “Slot” and came to its end; “Cam” (2) will hit “Tilting edge” (2); and the “Tiller” will rotate along its longitudinal axis by 90° clockwise. Accordingly the “Flap” at the other end of the “Tiller” will change its position from negative to positive and the situation of the “Cams” will be just similar to those of “Tiller” B in the same Figure.

On the other side (the back side of the same controller) “Tiller” C in FIG. (19) as it is leaving zone above dashed line AA with its positive “Flap” to enter the zone below dashed line AA we can see “Cam” (2) sliding along the upper “Slot” and came to its end; “Cam” (1) will hit “Tilting edge” (1); and the “Tiller” will rotate along its longitudinal axis by 90° counterclockwise. Accordingly, the “Flap” at the other end of the “Tiller” will change its position from positive to negative and the situation of the “Cams” will be just similar to those of “Tiller” D in the same Figure.

What is claimed is:

1. Using a set of “Tilting flaps” to drive an electric power generator (or a gearbox).

2. “Tilting flaps” are capable to automatically adjust their positions to be perpendicular to the wind current direction (Positive position) or parallel to the wind current direction (Negative position) in predetermined locations during its rotation around the generator (or gearbox) axis.
